(19) United States
(12) Patent Application Publication
(10) Pub. No.: US 2004/0057653 A1
(43) Pub. Date: Mar. 25, 2004

(54) Integrated optical element, integrated optical element fabrication method, and light source module

(75) Inventors: Chie Fukuda, Yokohama-shi (JP); Tsukuru Katsuyama, Yokohama-shi (JP); Akira Yamaguchi, Osaka (JP); Takashi Sasaki, Yokohama-shi (JP)

Correspondence Address: MCDERMOTT WILL & EMERY, 600 13TH STREET, N.W., WASHINGTON, DC, 20005-3096, US

(73) Assignee: SUMITOMO ELECTRIC INDUSTRIES, LTD.

(21) Appl. No.: 10/667,668

(22) Filed: Sep. 23, 2003

(30) Foreign Application Priority Data
Sep. 25, 2002 (JP) P2002-279512

(51) Int. Cl. G02B 6/12; G02B 6/34

(52) U.S. Cl. 385/14; 385/37

(57) ABSTRACT

The present invention relates to an integrated optical element and so forth in which an optical waveguide having favorable characteristics such as polarization dependence is integrated with an optical semiconductor element. The integrated optical element comprises a silicon bench having an element mount surface; an optical circuit element; and an optical semiconductor element. The optical circuit element includes an optical waveguide in which a grating is formed, and a substrate different from the silicon bench, and the optical semiconductor element constitutes an external resonator together with the grating. The optical circuit element and the optical semiconductor element are fixed onto the element mount surface of the silicon bench via a bonding material, while being apart from the silicon bench at a predetermined distance.

### BACKGROUND OF THE INVENTION

1. Field of the Invention

The present invention relates to an integrated optical element in which an optical semiconductor element, such as a semiconductor laser element or a semiconductor optical amplifier, and an optical waveguide in which light output from the optical semiconductor element propagates are integrated, and relates to an integrated optical element fabrication method, and a light source module including the integrated optical element.

2. Related Background Art

Conventionally, integrated optical elements, in which an optical semiconductor element that is an optical element for generating or amplifying light of a predetermined wavelength, and an optical waveguide in which light output from the optical semiconductor element propagates are integrated, as in the case of a semiconductor laser element (LD: Laser Diode) and a semiconductor optical amplifier (SOA: Semiconductor Optical Amplifier), are known. Examples of this kind of integrated optical element include the integrated optical elements disclosed by Japanese Patent Application Lain-Open Nos. H11-97784 and H11-211924, for example.

Japanese Patent Application Laid-Open No. H11-97784 discloses an external resonator-type frequency stabilized laser comprising a semiconductor laser element and an optical waveguide formed having an optically induced grating. Further, Japanese Patent Application Lain-Open No. H11-211924 discloses an optical circuit in which a silica-based optical waveguide, silica-based optical coupler, and a plurality of semiconductor laser chips of different oscillation wavelengths are integrated.

### SUMMARY OF THE INVENTION

The present inventors discovered the following problems as a result of investigating the above conventional technologies. That is, in the case of all of the above-described conventional integrated optical elements, the optical semiconductor element and optical waveguide are built on the same silicon (Si) substrate. More specifically, an optical circuit includes a planar waveguide-type optical waveguide is formed on a silicon substrate and an optical semiconductor element chip such as a semiconductor laser element chip is mounted with part of the surface of the silicon substrate on which the optical waveguide is formed.

In this constitution, from the standpoint of the heat dissipation and so forth of the optical semiconductor element, a silicon substrate is preferable as the substrate for mounting an optical semiconductor element such as a semiconductor laser element for outputting light. Further, this silicon substrate makes it possible to accurately form the V grooves and so forth for mounting the optical fiber. However, when an optical waveguide is formed on a silicon substrate, there is the problem that polarization dependence caused by stress-induced birefringence is great, and it is therefore difficult to obtain a favorable optical waveguide.

This invention was conceived in order to resolve the above-mentioned problems, and an object is to provide an integrated optical element in which an optical waveguide having favorable characteristics such as polarization dependence is integrated with an optical semiconductor element, an integrated optical element fabrication method, and a light source module.

In order to achieve the above object, the integrated optical element according to the present invention comprises an optical semiconductor element, an optical circuit element, and a silicon bench having an element mount surface on which the optical semiconductor element and optical circuit element are fixed via a bonding material. The optical semiconductor element includes a light emission layer and outputs light of a predetermined wavelength. The optical circuit element includes a substrate, an optical waveguide provided in correspondence with the optical semiconductor element on the substrate, and a grating formed in the optical waveguide and constituting an external resonator together with the associated optical semiconductor element. Further, the optical semiconductor element is mounted in a flip chip state such the light emission layer is located next to the element mount surface.

Furthermore, the integrated optical element fabrication method according to the present invention involves preparing the above-mentioned silicon bench, preparing the optical semiconductor element, preparing the optical circuit element, and sequentially fixing the optical semiconductor element and optical circuit element on the element mount surface of the silicon bench via the bonding material.

Further, in accordance with the integrated optical element and fabrication method thereof according to the present invention, the optical semiconductor element, which is a semiconductor laser element or a semiconductor optical amplifier, and the optical circuit element, includes an optical waveguide corresponding to this optical semiconductor element, are prepared separately. Further, the integrated optical element is constituted by mounting this optical semiconductor element and optical circuit element on a predetermined surface of the silicon bench that is a substrate prepared separately from the substrate included in the optical circuit element.

As a result of this constitution, the substrates of suitable materials can be used as the substrate on which the optical semiconductor element is mounted and the substrate on which the optical waveguide is formed. Therefore, an integrated optical element having favorable characteristics such as polarization dependence, in which an optical waveguide is integrated with an optical semiconductor element, and a fabrication method therefor realizing favorable characteristics such as polarization dependence can be obtained. Furthermore, because optical devices of two types are fabricated separately, the fabrication yield of the integrated optical element can be improved.

Further, in the case of the integrated optical element according to the present invention, the light emission layer of the optical semiconductor element is shifted further toward the outer periphery side of the cross-section than the center of the cross-section of the optical semiconductor element that is orthogonal to the light emission layer, and the optical waveguide of the optical circuit element is also shifted further toward the outer boundary of the cross-section than the center of the cross-section of the optical circuit element that is orthogonal to the optical waveguide. Here, all of the elements are preferably arranged on the element mount surface of the silicon bench such that the distance between the silicon bench, and the light emission layer and optical waveguide is minimized. In other words, the optical semiconductor element and the optical circuit element are mounted in a flip chip state such that the light emission layer and the optical waveguide are respectively located next to the element mount surface of the silicon bench. As a result, the alignment accuracy between the optical axis of the optical semiconductor element and the optical axis of the optical waveguide of the optical circuit element can be improved.

Further, the optical semiconductor element preferably includes a semiconductor optical amplifier whose end face that faces the optical waveguide is AR (Anti-Reflection) coated. As described above, a grating constituting an external resonator for the semiconductor optical amplifier is formed in the optical waveguide of the optical circuit element. As a result, an integrated optical element having an external resonator-type light source having favorable characteristics such as polarization dependence is obtained.

In addition, in place of the above-mentioned semiconductor optical amplifier, the integrated optical element according to the present invention may include N (where N is an integer of 2 or more) semiconductor optical amplifiers each having the same structure as the semiconductor optical amplifier, and an optical circuit element including N optical waveguides each corresponding to the associated one of the N semiconductor optical amplifiers. In this case, these N optical semiconductor elements and the optical circuit element are mounted on the element mount surface of the silicon bench via a bonding material. Further, each of gratings with mutually different reflection peak wavelengths is respectively formed in the associated one of N optical waveguides in the optical circuit element. By means of this constitution, an integrated optical element comprising a multi-channel light source (constituted by a plurality of external resonator-type light sources of different oscillation wavelengths) is obtained.

In this case, the optical circuit element may include an optical multiplexer for multiplexing the light propagating through the N optical waveguides.

The interval between the end face of the optical semiconductor element facing the optical waveguide and the optical waveguide of the optical circuit element is preferably filled with resin. As a result, light that is reflected back from the end face of the optical circuit element to the optical semiconductor element is effectively reduced. In such a constitution, the encapsulated resin preferably has a refractive index of 1.300 or more but 1.444 or less, whereby the reflected light is adequately diminished.

Further, the end face of the optical circuit element facing the optical semiconductor element is preferably inclined at an angle of 3° or more but 8° or less with respect to a surface that is orthogonal to the optical axis of the light from the optical semiconductor element. As a result, light that is reflected back from the end face of the optical circuit element to the optical semiconductor element is effectively reduced.

The substrate of the optical circuit element is preferably a silica-based substrate. Because an optical waveguide is thus formed on a silica-based substrate, an optical waveguide having favorable characteristics such as polarization dependence is obtained.

Meanwhile, the optical semiconductor element preferably constitutes a spot size conversion structure (SSC structure) whose FFP (the angle spread of the far field pattern) is 15° or less, and the optical circuit element preferably has a relative refractive index difference between the core and the cladding of the optical waveguide is preferably 1.0% or more. It is therefore possible to match the diameter of the light propagating from the optical semiconductor element to the end face of the optical circuit element, and the mode field diameter (MFD) of the optical waveguide, and, consequently, the efficiency of the coupling between the optical semiconductor element and the optical waveguide can be raised.

Further, according to the fabrication method of the integrated optical element according to the present invention, the glass film of the core and the cladding that constitute the optical waveguide of the optical circuit element are preferably formed by CVD. Because the optical waveguide is formed by CVD with good film thickness control, the alignment accuracy of the optical axis of the optical waveguide with respect to the optical axis of the optical semiconductor element can be improved.

Further, V grooves for mounting the optical fibers to which the light from the optical waveguides in the optical circuit element is input, and alignment marks for recognition by a die bonder when the optical semiconductor element and the optical circuit element are mounted, are preferably formed batchwise on the element mount surface of the silicon bench by means of a KOH etching process. As a result, the accuracy of the mutual alignment between the optical semiconductor element, the optical waveguide of the optical circuit element, and the optical fibers can be raised.

After mounting the optical semiconductor element in a predetermined region on the element mount surface of the silicon bench, the optical circuit element is preferably mounted in a different region from this predetermined region on the element mount surface. As a result, a variation in the characteristics caused by heat generated in the optical circuit element during fabrication of the integrated optical element is effectively suppressed.

The light source module according to the present invention further comprises an integrated optical element that has the structure described above, and outputs light from the light source constituted by the optical semiconductor element and the optical circuit element. In this case, an optical transmission light source module whose light source is an integrated optical element having favorable characteristics such as polarization dependence is obtained.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 shows a cross-sectional structure (cross-sectional structure parallel to the direction of light propagation) of a first embodiment of the integrated optical element according to the present invention;

FIG. 2 is a top view showing the planar structure of the integrated optical element according to the first embodiment shown in FIG. 1;

FIG. 3 is a top view that shows the planar structure of the silicon bench of the integrated optical element according to the first embodiment shown in FIG. 1;

FIG. 4 shows a cross-sectional structure (cross-sectional structure perpendicular to the direction of light propagation) of the integrated optical element according to the first embodiment (FIG. 1), along the line I-I in FIG. 2;

FIG. 5 shows a cross-sectional structure (cross-sectional structure perpendicular to the direction of light propagation) of the integrated optical element according to the first embodiment (FIG. 1), along the line II-II in FIG. 2);

FIGS. 6A and 6B are a side view and a top view respectively that show the constitution in which the integrated optical element according to the first embodiment shown in FIG. 1 is filled with resin;

FIGS. 7A to 7D are process diagrams that serve to illustrate the fabrication method of the integrated optical element according to the first embodiment shown in FIG. 1;

FIGS. 8A to 8C are graphs showing optical characteristics of the integrated optical element according to the first embodiment shown in FIG. 1;

FIG. 9 is a graph showing coupling loss between the SOA and the optical waveguide of the integrated optical element according to the first embodiment shown in FIG. 1;

FIG. 10 is a graph showing coupling loss between the SOA and the optical waveguide of the integrated optical element according to the first embodiment shown in FIG. 1;

FIG. 11 shows the cross-sectional structure (cross-sectional structure parallel to the direction of light propagation) of a second embodiment of the integrated optical element according to the present invention;

FIG. 12 is a top view showing the parallel structure of the integrated optical element according to the second embodiment arbitrarily shown in FIG. 11;

FIG. 13 is a top view showing a planar structure of a silicon bench of the integrated optical element according to the second embodiment shown in FIG. 11;

FIG. 14 is a partially exploded cross-section showing the constitution of the first embodiment of the light source module according to the present invention; and

FIG. 15 is a perspective view showing the constitution of the second embodiment of the light source module according to the present invention.

### DESCRIPTION OF THE PREFERRED EMBODIMENTS

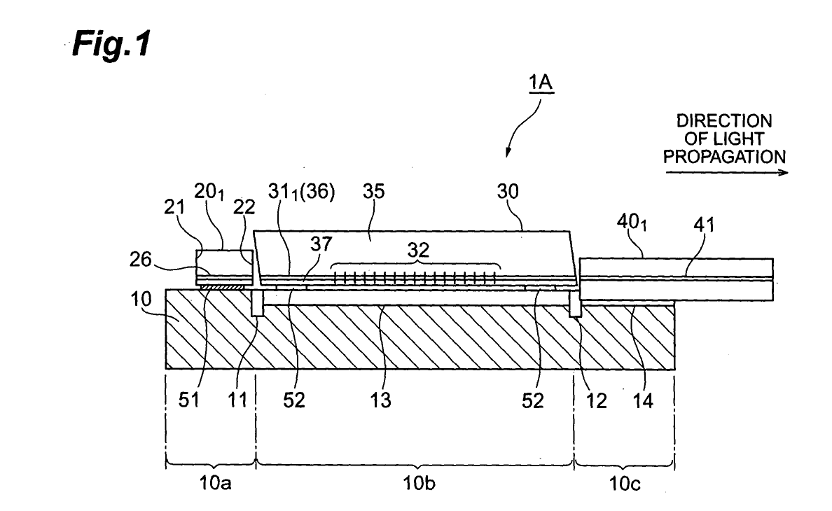

Embodiments of the integrated optical element and the like according to the present invention will be described in detail hereinbelow by using FIGS. 1 to 5, 6A to 8C, and 9 to 15. In the description of the drawings, the same symbols are assigned to the same elements such that repetitive description is avoided. Further, the dimensional scaling of the drawings does not necessarily match that of the description.

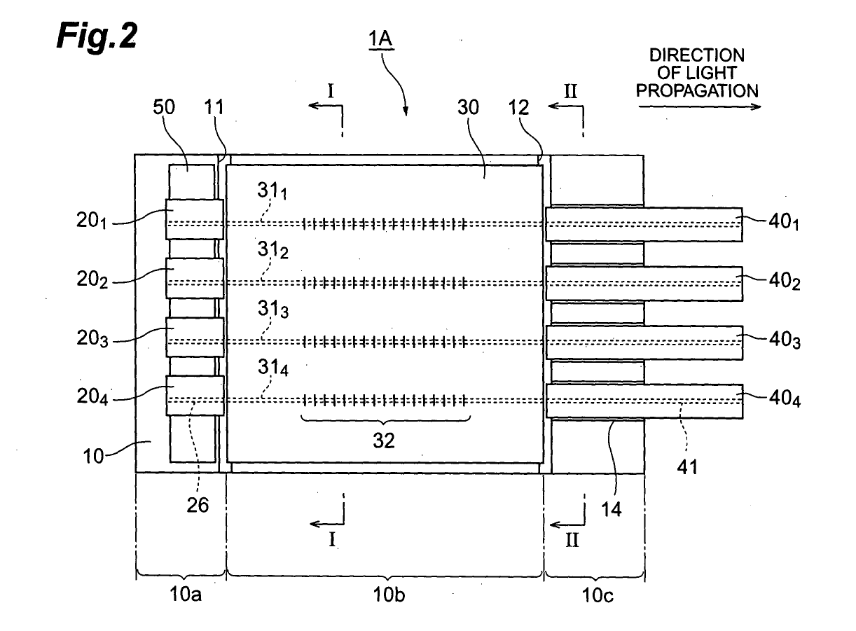

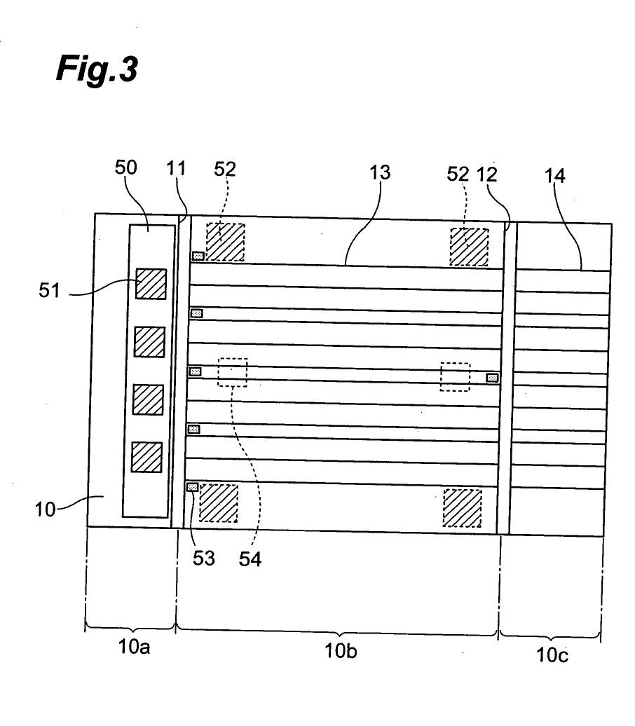

FIG. 1 shows the cross-sectional structure of a first embodiment of the integrated optical element according to the present invention. Further, FIG. 2 is a top view showing the planar structure of the integrated optical element according to the first embodiment shown in FIG. 1. FIG. 1 shows a cross-section that contains the optical axis of a semiconductor optical amplifier 20₁, an optical waveguide 31₁, and an optical fiber 40₁ (that will be described later) that is parallel to the direction of light propagation of the integrated optical element. Further, FIG. 3 is a top view that shows the planar structure of the silicon bench of the integrated optical element according to the first embodiment shown in FIG. 1 in a state where the constituent elements of the integrated optical element mounted on the silicon bench are excluded.

An integrated optical element 1A according to the first embodiment comprises a silicon bench 10 consisting of a silicon (Si) substrate; a semiconductor optical amplifier (SOA) 20; an optical circuit element 30; and an optical fiber 40.

The silicon bench 10 comprises an element mount surface for mounting the element chips of the SOA 20 and optical circuit element 30. The element mount surface of the silicon bench 10 is constituted by a first mount surface 10a for mounting the SOA 20, a second mount surface 10b for mounting the optical circuit element 30, and a third mount surface 10c for mounting the optical fiber 40, moving in a direction from the upstream side to the downstream side in the direction of light propagation. An insulation film is also formed on the element mount surface of the silicon bench 10.

The SOA 20 is an optical semiconductor element for amplifying light. The integrated optical element 1A shown in FIGS. 1 and 2 comprises four of the SOA 20, namely SOA 20₁ to 20₄. Each of these SOA 20ᵢ (i=1 to 4) is constituted such that the end face 21 on the upstream side with respect to the direction of light propagation is HR (High-Reflection) coated, and the end face 22 on the downstream side facing the optical circuit element 30 is AR (Anti-Reflection) coated. As a result of this structure, the SOA 20ᵢ function as optical amplifiers.

These SOA 20₁ to 20₄ are preferably mounted (see FIG. 3) on the first mount surface 10a of the silicon bench 10 via bonding pads 51 consisting of AuSn, in a parallel arrangement on the first mount surface 10a. Further, as shown in FIG. 1, the SOA 20ᵢ are mounted on the silicon bench 10 such that the light emission layer 26 of the SOA 20ᵢ is close to the first mount surface 10a (such that the stacked film face lying opposite the substrate with the light emission layer 26 interposed therebetween face toward the silicon bench 10). Further, alignment marks formed from an electrode material are formed on the stacked film face of the SOA 20ᵢ. Furthermore, an electrode 50 consisting of TiPtAu is preferably provided on the first mount surface 10a of the silicon bench 10 whereon the SOA 20₁ to 20₄ are mounted.

The optical circuit element 30 is a planar waveguide-type optical circuit element that comprises a substrate, and an optical waveguide that is provided on the substrate. The optical circuit element 30 comprises a silica-based substrate 35; an optical waveguide layer having a predetermined waveguide pattern which is formed on the stacked film face of the silica-based substrate 35; and over-cladding 37 that is formed so as to cover the silica-based substrate 35 and optical waveguide layer.

In this first embodiment, the optical waveguide layer on the silica-based substrate 35 is a waveguide pattern that comprises four cores 36 in a mutually parallel arrangement, the direction of light propagation being the longitudinal direction. Accordingly, the optical circuit element 30 comprises four optical waveguides 31₁ to 31₄. Further, each of these optical waveguides 31ᵢ (i=1 to 4) is constituted such that the optical axis thereof is provided in a position matching the optical axis of the corresponding SOA 20ᵢ, such that the light from the SOA 20ᵢ propagates through the optical waveguides 31ᵢ.

Furthermore, optically induced Bragg gratings 32 having a predetermined reflection peak wavelength are formed in the optical waveguides 31₁ to 31₄. Further, an external resonator-type light source for generating light of a predetermined wavelength is constituted by the SOA 20ᵢ for amplifying light, and the gratings 32 provided in the associated optical waveguides 31ᵢ. In addition, the gratings 32 provided in the optical waveguides 31₁ to 31₄ have mutually different reflection peak wavelengths. As a result, the integrated optical element 1A is a four-channel light source that is constituted by four external resonator-type light sources having different oscillation wavelengths.

The optical circuit element 30 comprising these optical waveguides 31₁ to 31₄ is preferably mounted on a second mount surface 10b of the silicon bench 10 via a bonding pad 52 consisting of AuSn (see FIG. 3). Further, as shown in FIG. 1, the optical circuit element 30 is mounted on the second mount surface 10b such that the optical waveguide layer comprising the cores 36 is located next to the second mount surface 10b (such that the stacked film face lying opposite the substrate 35 with respect to the optical waveguide layer are next to the silicon bench 10).

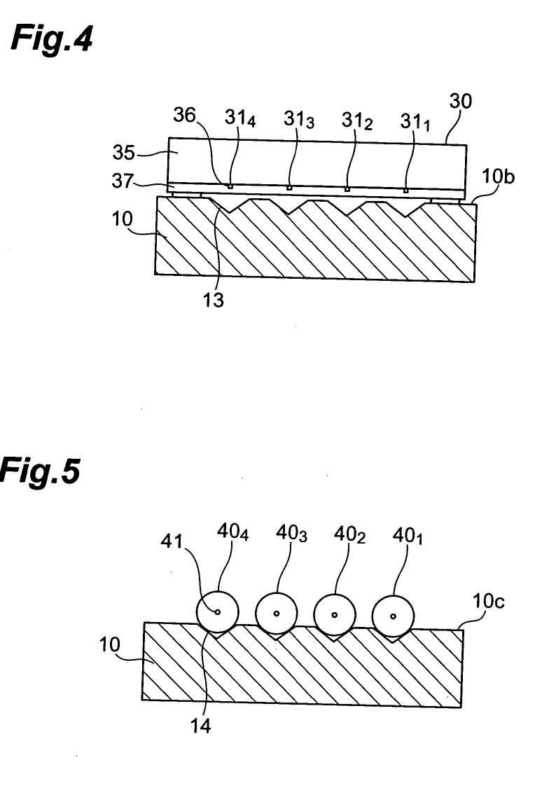

FIG. 4 shows the cross-sectional structure (cross-sectional structure perpendicular to the direction of light propagation) of the integrated optical element according to the first embodiment (FIG. 1), along the line I-I in FIG. 2. In this FIG. 4, the cross-sectional structure perpendicular to the direction of light propagation of the integrated optical element 1A is shown in a position comprising the optical circuit element 30 comprising the optical waveguides 31₁ to 31₄. As shown in FIGS. 3 and 4, four V grooves 13 are formed in the second mount surface 10b of the silicon bench 10, so as to follow the optical waveguides 31₁ to 31₄. In addition, a dicing groove 11 is provided in the silicon bench 10, between the first mount surface 10a for mounting the SOA 20₁ to 20₄, and the second mount surface 10b for mounting the optical circuit element 30.

The optical fiber 40 is an optical waveguide for transmitting light outputted from the SOA 20 and propagates through the optical waveguide 31. In the first embodiment, four of the optical fiber 40 are arranged, namely optical fibers 40₁ to 40₄. Each of the optical fibers 40ᵢ (i=1 to 4) is arranged such that the optical axis of the core 41 thereof is disposed in a position matching the optical axis of the associated optical waveguide 30ᵢ, and the light from the optical waveguides 31ᵢ is thus input to the optical fibers 40ᵢ.

These optical fibers 40₁ to 40₄ are mounted on the third mount surface 10c of the silicon bench 10 in a mutually parallel arrangement.

FIG. 5 shows the cross-sectional structure (cross-sectional structure perpendicular to the direction of light propagation) of the integrated optical element according to the first embodiment (FIG. 1), along the line II-II in FIG. 2). FIG. 5 also shows the optical fibers 40₁ to 40₄. As shown in FIGS. 3 to 5, four V grooves 14 are formed in the third mount surface 10c of the silicon bench 10. The optical fibers 40₁ to 40₄ are fixed to the top of the third mount surface 10c such that each is aligned by the associated V groove 14. In addition, a dicing groove 12 is provided in the silicon bench 10, between the second mount surface 10b for mounting the optical circuit element 30, and the third mount surface 10c for mounting the optical fibers 40₁ to 40₄.

As shown by the solid lines in FIG. 3, the bonding pads 51 for mounting the SOA 20₁ to 20₄ on the silicon bench 10 are provided on the first mount surface 10a of the silicon bench 10. Further, as indicated by the broken lines in FIG. 3, bonding pads 52 for mounting the optical circuit element 30 comprising the optical waveguides 31₁ to 31₄ on the silicon bench 10 are preferably provided via a metal layer consisting of TiPtAu on the surface of the cladding 37 on the optical circuit element 30 side opposite the second mount surface 10b of the silicon bench 10.

In addition, alignment marks 53 for recognition by the die bonder when the SOA 20₁ to 20₄ and optical circuit element 30 are mounted on the element mount surface, are formed on the second mount surface 10b of the silicon bench 10. Likewise, alignment marks 54 are formed on the surface of the cladding 37 of the optical circuit element 30.

Next, a description will be provided specifically with regard to the effects of the integrated optical element according to the first embodiment.

In order to fabricate the integrated optical element 1A according to the first embodiment shown in FIGS. 1 to 5, two types of optical devices, namely the SOA 20₁ to 20₄, which are optical semiconductor elements, and the optical circuit element 30 comprising the optical waveguides 31₁ to 31₄, are prepared separately. Further, the integrated optical element 1A is constituted by mounting the SOA 20₁ to 20₄ and the optical circuit element 30 on the first and second mount surfaces 10a and 10b respectively of the silicon bench 10, which are substrates that are provided separately from the substrate 35 of the optical circuit element 30.

As described above, in this first embodiment, substrates of a suitable material can be applied as the substrate on which the SOA 20₁ to 20₄ are mounted and the substrate whereon the cores 36 and cladding 37 of the optical waveguides 31₁ to 31₄ are formed. Therefore, the integrated optical element 1A, in which the optical waveguides 31₁ to 31₄ having favorable characteristics such as polarization dependence are integrated with the SOA 20₁ to 20₄, is obtained. Further, by fabricating the two types of optical devices separately, the fabrication yield of the integrated optical element 1A can be improved.

As detailed above, a silica-based substrate is preferable for the substrate 35 whereon the cores 36 and cladding 37 of the optical waveguides 31₁ to 31₄ of the optical circuit element 30 are formed. Therefore, because an optical waveguide constituted by a core and cladding is formed on a silica-based substrate, an optical waveguide having favorable characteristics such as polarization dependence is obtained.

When a silica-based substrate is applied as the substrate 35 as described above, the bonding pads 52 for mounting the optical circuit element 30 on the silicon bench 10 are preferably arranged at the four corners of the optical circuit element 30, as shown in FIG. 3. As a result, contact between the optical circuit element 30 and the silicon bench 10 caused by warping of the substrate 35 is effectively suppressed.

As shown in FIGS. 3 and 4, V grooves 13 are preferably formed in positions corresponding with the second mount surface 10b of the silicon bench 10, with respect to the optical waveguides 31, to 314 of the optical circuit element 30. For example, when the cladding 37 is formed by CVD, the surface above the cores 36 of the optical circuit element 30 is sometimes convex. Accordingly, because the V grooves 13 are provided, contact between the convex portion of the optical circuit element 30 and the silicon bench 10 is suppressed, and a contact-induced increase in guided wave loss, and an optical axis displacement, and so forth, are effectively prevented.

Further, in the first embodiment, the SOA 20₁ to 20₄ and the optical circuit element 30, which are optical semiconductor elements, are arranged such that the light emission layer and optical waveguide layer, respectively, are located next to the element mount surface of the silicon bench 10. As a result, even in the case of non-alignment, for example, the accuracy of the alignment between the optical axis of the SOA 20₁ to 20₄ and the optical axis of the optical waveguides 31₁ to 31₄ of the optical circuit element 30 improves.

The position of the optical axis in a perpendicular direction can be aligned in accordance with the film stacking accuracy and RIE accuracy, and so forth, when each element is fabricated, and in accordance with the conditions with which the AuSn is heated when each element is mounted via the bonding pads 51 and 52 on the silicon bench 10.

In this case, the glass films of the cores 36 and cladding 37, which form the optical waveguides 31₁ to 31₄, are preferably formed by CVD. In addition, the films for the electrodes consisting of TiPtAu, and so forth, or for the bonding pads consisting of AuSn are preferably formed by vapor deposition. Thus, because films are stacked by using a method with good film thickness control, favorable optical axis alignment accuracy is obtained.

Meanwhile, the position of the optical axis in a horizontal direction can be aligned by allowing the alignment marks 53 and 54 to be distinguished in high accuracy dicing when the SOA 20₁ to 20₄ and the optical circuit element 30 are mounted.

In this case, when the silicon bench 10 is fabricated, the alignment marks 53, and the V grooves 14 for mounting the optical fibers 40₁ to 40₄ are preferably formed batchwise on the element mount surface using the same photomask by means of a KOH etching process. As a result, displacement between the alignment marks and V grooves is suppressed, and the mutual alignment accuracy of the SOA 20₁ to 20₄, the optical waveguides 31₁ to 31₄ of the optical circuit element 30₁ and optical fibers 40₁ to 40₄ is raised.

Similarly, also when the optical circuit element 30 is fabricated, the alignment marks 54 are preferably formed by using the same photomask as that for the metal layer. As a result, displacement between the alignment marks and the cores of the optical waveguides is also suppressed.

Further, the shape of each part of the integrated optical element 1A, and the V groove width, insulation film thickness, electrode thickness, bonding pad thickness, cladding thickness, metal layer thickness, and so forth, for example, are suitably designed for a match between the optical axis of the SOA 20₁ to 20₄, the optical axis of the optical waveguides 31, to 314 of the optical circuit element 30, and the optical axis of the optical fibers 40₁ to 40₄.

Furthermore, in the first embodiment, the dicing grooves 11 and 12 are provided in the element mount surface of the silicon bench 10, between the first mount surface 10a and second mount surface 10b, and the second mount surface 10b and third mount surface 10c respectively. As a result, the introduction of foreign matter between the SOA 20₁ to 20₄ and optical circuit element 30, and between the optical circuit element 30 and optical fibers 40₁ to 40₄ is prevented.

The film thickness of the electrode 50 formed by TiPtAu or similar on the element mount surface of the silicon bench 10 maybe on the order of 0.56 μm, for example. Further, the film thickness of the bonding pads 51 formed by AuSn or similar maybe on the order of 1.5 μm, for example. When these film thicknesses are too thin, bond strength is not obtained, whereas excessive thickness results in a large optical axis displacement.

The end face of the optical circuit element 30 which faces the SOA 20ᵢ is preferably inclined at a predetermined angle of 3° or more but 8° or less, for example at an angle of 4.5°, with respect to a surface that is orthogonal to the optical axis of the light from the SOA 20ᵢ (the surface that is orthogonal to the element mount surface of the silicon bench 10) (See the cross-sectional view of FIG. 1). The light reflected back from the end face of the optical circuit element 30 to the SOA 20ᵢ is thus diminished.

When the inclination angle of the end face of the optical circuit element 30 is greater than 8°, the interval between the SOA 20ᵢ and the optical circuit element 30 must be widened so that the optical circuit element 30 does not make contact with the SOA 20ᵢ, and hence coupling loss between the optical circuit element 30 and the SOA 20ᵢ is then large. In addition, when the inclination angle is less than 3°, an adequate reflected light reduction effect is not obtained. Further, in the constitution shown in FIG. 1, the end face of the optical circuit element 30 which faces the optical fiber 40ᵢ is also formed inclined in the same manner. Further, the distance between the end face of the SOA 20ᵢ and the end face of the optical circuit element 30 is on the order of 20 μm, for example.

In addition, the SOA 20ᵢ preferably has a spot size conversion structure (SSC structure) of which the FFP (the angle spread of the far field pattern) is 15° or less, for example 12°. Further, the optical circuit element 30 is preferably constituted such that the relative refractive index difference Δn between the cores 36 and the cladding 37 of the optical waveguides 31ᵢ is preferably 1.0% or more, for example Δn=1.5%. It is therefore possible to match the diameter of the light propagating from the SOA 20ᵢ to the end faces of the optical waveguides 31ᵢ of the optical circuit element 30, and the mode field diameter (MFD) of the optical waveguides 31ᵢ, and, consequently, a low threshold-value, high-output integrated optical element 1A in which the efficiency of the coupling between the SOA 20ᵢ and the optical waveguides 31ᵢ is high is obtained.

Furthermore, the interval between the end face of the SOA 20₁ to 20₄ next to the optical waveguides 31₁ to 31₄, and the end face of the optical waveguides 31₁ to 31₄ of the optical circuit element 30 is preferably filled with resin. As a result, the light reflected back from the end face of the optical circuit element 30 to the SOA 20₁ to 20₄ is effectively diminished. Further, because the refractive index of the encapsulated resin is between 1.3 and 1.444, the reflected light is adequately diminished.

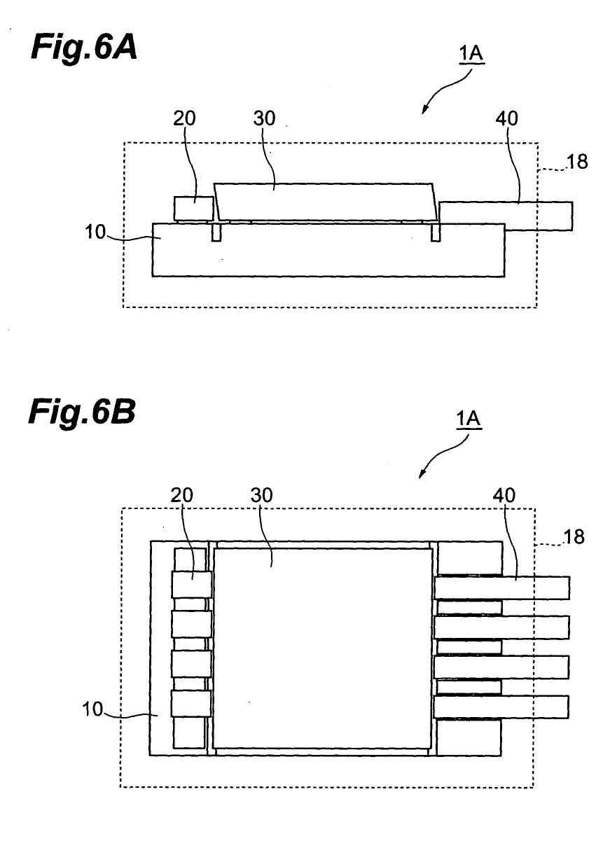

As a specific example of the above-described constitution in which resin is encapsulated, the whole of the silicon bench 10, the SOA 20₁ to 20₄, and the optical circuit element 30 that constitute the integrated optical element 1A may be covered by resin 18, as indicated by the broken lines in the side view of FIG. 6A and the top view of FIG. 6B, for example. Further, other constitutions are also possible. Further, in these constitutions, the AR coat of the downstream side end face 22 of the SOA 20₁ to 20₄ is designed on the basis of the refractive index of the resin 18.

When light of a 1.55 μm wavelength band is assumed, resin of a refractive index of 1.4 can be employed, for example. When the refractive index of the resin is less than 1.3, the coupling loss at each join end face is then large. Further, when the refractive index is larger than 1.444, in cases where the thickness of the cladding of the optical circuit element is thin, leakage of light occurs next to the resin, and hence the guided wave loss of the optical waveguide increases.

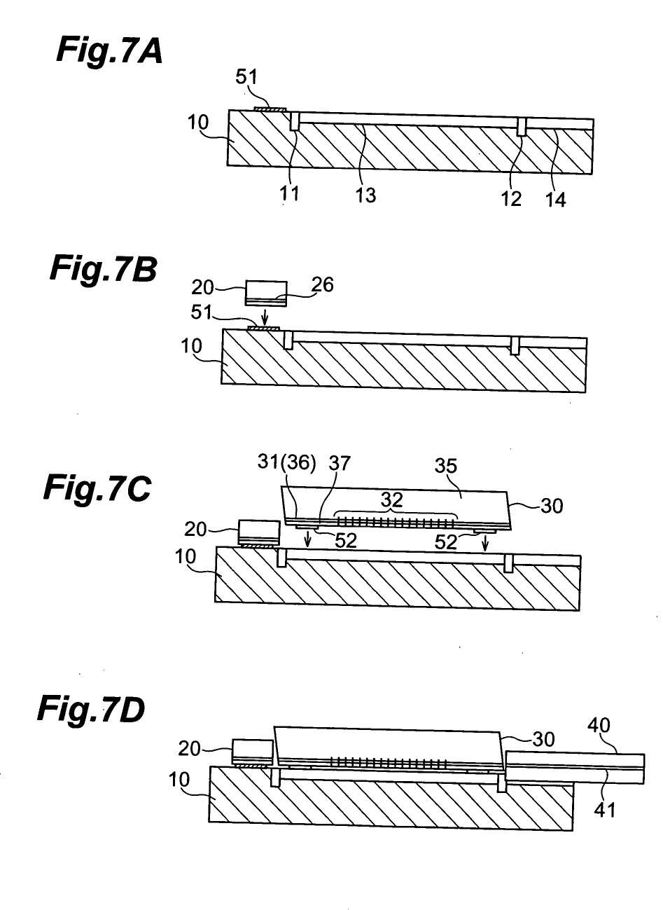

Next, the fabrication method for the integrated optical element 1A shown in FIGS. 1 to 5 will be described together with a specific constitutional example of the integrated optical element 1A. FIGS. 7A to 7D are process diagrams that serve to illustrate the fabrication method of the integrated optical element 1A according to the first embodiment shown in FIG. 1. Further, each process shown in FIGS. 7A to 7D is shown by means of the same cross-sectional view as FIG. 1.

First, the silicon bench 10, which is a substrate for mounting the SOA 20₁ to 20₄, which are optical semiconductor elements, and the optical circuit element 30, is fabricated (FIG. 7A). One face of the silicon bench 10 constitutes the element mount surface. The dicing grooves 11 and 12, V grooves 13 and 14, an insulation film, the electrode 50 consisting of TiPtAu, and the alignment marks 53 are formed in this element mount surface, and the bonding pads 51 consisting of AuSn, which are for mounting the SOA 20₁ to 20₄, are formed on the electrode 50. The thickness of the TiPtAu of the electrode 50 is approximately 0.56 μm, and the thickness of the AuSn of the bonding pads 51 is approximately 1.5 μm. Further, the alignment marks 53 are formed using the same photomask as for the formation of the V grooves 13 and 14 by means of KOH etching.

Next, the four prepared SOA 20₁ to 20₄ are mounted on the first mount surface 10a of the element mount surface of the silicon bench 10 (FIG. 7B). When the SOA 20ᵢ are fabricated, the electrode consisting of Au is formed by means of vapor deposition rather than plating and is formed approximately 1 μm thick. Because the electrode is thus formed by means of vapor deposition, it is possible to reduce a variation in the electrode thickness to about 1 μm±0.1 μm. Further, the SOA 20ᵢ has an SSC structure, the FFP being 12°.

The SOA 20₁ to 20₄ thus fabricated are loaded onto the first mount surface 10a via the bonding pads 51 formed on the silicon bench 10 by using high precision die bonder in a flip chip state where the stacked film layer, whereon the light emission layer 26 and the electrode and so forth are formed, is next to the silicon bench 10. Here, the SOA 20₁ to 20₄ are secured by fusing together the AuSn of the bonding pads 51 next to the silicon bench 10, and the Au of the electrode face next to the SOA 20, to 204, through the application of heat.

Thereafter, the optical circuit element 30, which comprises the optical waveguides 31₁ to 31₄, is mounted on the second mount surface 10b of the element mount surface of the silicon bench 10 (FIG. 7C). When the optical circuit element 30 is fabricated, an optical waveguide layer that is 4.5 μm thick is deposited by plasma CVD on a silica-based wafer which is the silica-based substrate 35. By processing this deposition layer to produce the optical waveguide layer by means of photolithography and RIE to a depth of 4.6 μm, pattern cores 36 that are associated with the four optical waveguides 31₁ to 31₄ are formed. Then, over-cladding 37 that is 12.6 μm thick is deposited by plasma CVD so as to cover the silica-based substrate 35 and the cores 36.

Here, on account of the optical axis alignment between the SOA 20ᵢ and the optical waveguides 31ᵢ of the optical circuit element 30, the thickness of the over-cladding 37 is about half the thickness (approximately 20 μm) of an ordinary planar optical waveguide. In addition, in order to raise the efficiency of the coupling by matching the SOA 20ᵢ and the mode field diameter (MFD), the relative refractive index difference between the cores 36 and the cladding 37 of the optical waveguides 31ᵢ is set such that Δn=1.5%. The interval between adjacent cores 36 is on the order of 500 μm.

A metal layer consisting of TiPtAu that is 0.56 μm thick is formed on the surface of the cladding 37 by means of vapor deposition and lift-off (or vapor deposition, photolithography, and RIE), and bonding pads 52 consisting of AuSn that are 1.5 μm thick are likewise formed on this metal layer by means of vapor deposition and lift-off. By means of this process and by setting the thickness of each layer, it is possible to keep the variation at or less than ±1 μm overall by matching the stacked film thickness and etching depth and so forth of each step. As a result, even when the optical circuit element 30 is mounted on the silicon bench 10 with non-alignment, the efficiency of the coupling between the SOA 20ᵢ and the optical waveguides 31ᵢ improves.

This planar waveguide-type optical circuit element 30 is placed on the wafer as is or cut to the appropriate size, and optically induced gratings 32 that have a predetermined reflectance, reflection wavelength bandwidth, and reflection peak wavelength are formed. In addition, in hydrogen processing and annealing, processing is carried out under normal conditions.

Here, the gratings 32 are preferably formed by estimating the amount of the change in the characteristics of the gratings 32 that is caused by the heat, stress and so forth involved in the subsequent bonding and packaging processes. Moreover, the gratings 32 of each of the optical waveguides 31₁ to 31₄ are formed so as to have mutually different reflection wavelength bandwidths and reflection peak wavelengths. After the gratings 32 have been formed, dicing is performed so that the inclination angle of the end face is 4.5°, and the wafer is divided into 2.5 mm×2.5 mm optical circuit element 30 chips.

The optical circuit element 30 that is fabricated as described above is mounted on the second mount surface 10b via the bonding pads 52 formed on the optical circuit element 30 by using high precision die bonder in a flip chip state where the stacked film layer, whereon the optical waveguides 31, to 314, the bonding pads 52, and so forth are formed, is next to the silicon bench 10. Here, the optical circuit element 30 is secured by fusing together the metal layer next to the silicon bench 10, and the AuSn of the bonding pads 52 next to the optical circuit element 30, through the application of heat.

In addition, the optical fibers 40₁ to 40₄ are mounted on the third mount surface 10c with respect to the silicon bench 10 whereon the SOA 20₁ to 20₄ and the optical circuit element 30 are mounted, whereby the integrated optical element 1A is obtained (FIG. 7D). Further, where required, a predetermined area that includes the silicon bench 10, the SOA 20₁ to 20₄, and the optical circuit element 30 is sealed by means of the resin 18 (See FIGS. 6A and 6B). For example, the integrated optical element 1A is mounted in a predetermined package, and, after wire bonding and fiber setting, the whole of the integrated optical element 1A is covered by resin that protects the SOA 20₁ to 20₄ from moisture and so forth. Here, resin is also made to fill the respective intervals between the SOA 20₁ to 20₄ and the optical circuit element 30, the optical circuit element 30 and the optical fibers 40₁ to 40₄, and the optical circuit element 30 and the silicon bench 10, and so forth.

The integrated optical element 1A that is thus fabricated is constituted as a four-channel light source that comprises a first external resonator-type light source, which comprises the SOA 20₁ and the optical waveguide 31₁ and outputs light of oscillation wavelength λ₁; a second external resonator-type light source, which comprises the SOA 20₂ and the optical waveguide 31₂ and outputs light of oscillation wavelength λ₂; a third external resonator-type light source, which comprises the SOA 20₃ and the optical waveguide 31₃ and outputs light of oscillation wavelength λ₃; and a fourth external resonator-type light source, which comprises the SOA 20₄ and the optical waveguide 31₄ and outputs light of oscillation wavelength λ₄.

Further, the oscillation wavelengths λ₁ to λ₄ of the integrated optical element 1A are set by the constitution of the SOA 20₁ to 20₄ and by the constitution of the gratings 32 of the optical waveguides 31₁ to 31₄, and so forth. In the case of a light source used in the 1.55 μm wavelength band, these oscillation wavelengths are set as λ₁=1537.2 nm, λ₂=1543.4 nm, λ₃=1550.0 nm, and λ₄=1556.4 nm, for example.

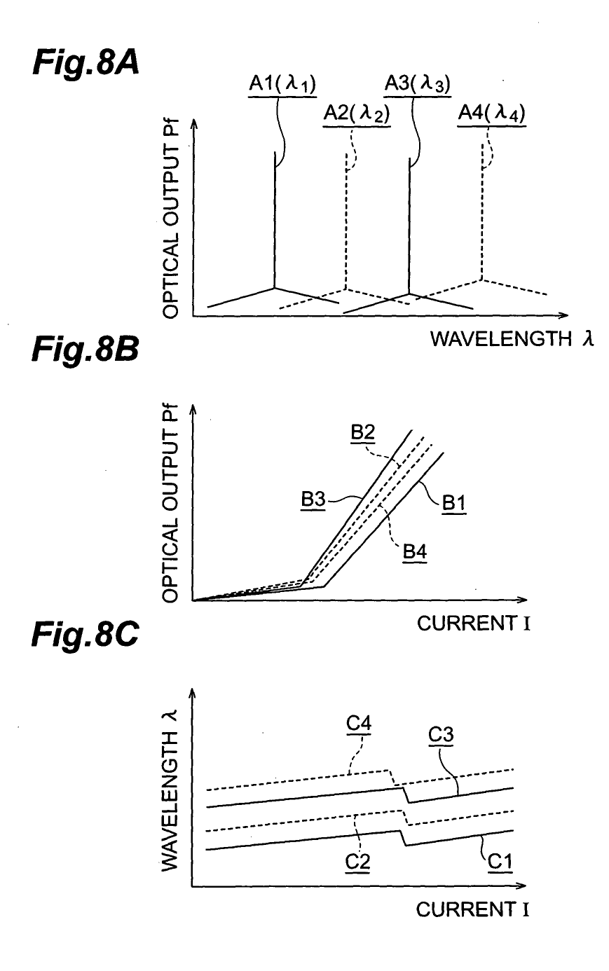

FIGS. 8A to 8C are graphs showing optical characteristics of the integrated optical element 1A according to the first embodiment shown in FIG. 1. In particular, FIG. 8A shows light emission spectra for the integrated optical element 1A, where graphs A1 to A4 correspond to the light emission spectra of the above-mentioned first to fourth light sources. Further, FIG. 8B is a graph showing the current-light output characteristic, where graphs B1 to B4 correspond to the characteristic of the first to fourth light sources. FIG. 8C is a graph showing the current-oscillation wavelength characteristic, where graphs C1 to C4 correspond to the characteristic of the first to fourth light sources.

Here, in case of the fabrication method for the integrated optical element shown in FIGS. 7A to 7D, the optical circuit element 30 is mounted after the SOA 20₁ to 20₄ have been mounted on the element mount surface of the silicon bench 10. Because the integrated optical element 1A is fabricated in this order, degradation of the gratings 32 formed in the optical waveguides 31₁ to 31₄ of the optical circuit element 30 that is caused by the heat involved in mounting is kept to a minimum.

Further, in accordance with this fabrication process, in the first embodiment, the bonding pads 52 for mounting the optical circuit element 30 on the silicon bench 10 are provided next to the optical circuit element 30 rather than next to the silicon bench 10.

When the bonding pads 52 used to mount the optical circuit element 30 are provided on the element mount surface of the silicon bench 10, melting takes place as far as the AuSn of the bonding pads 52 due to the heat involved in the mounting of the SOA 20₁ to 20₄, or deterioration sometimes occurs due to oxidation of the AuSn of the bonding pads 52. Accordingly, because the bonding pads 52 are provided next to the optical circuit element 30, the above-described process of sequentially mounting the SOA 20₁ to 20₄ and then the optical circuit element 30 on the silicon bench 10 can be suitably performed.

In addition, the constitution and characteristics of the integrated optical element 1A according to the first embodiment will now be studied.

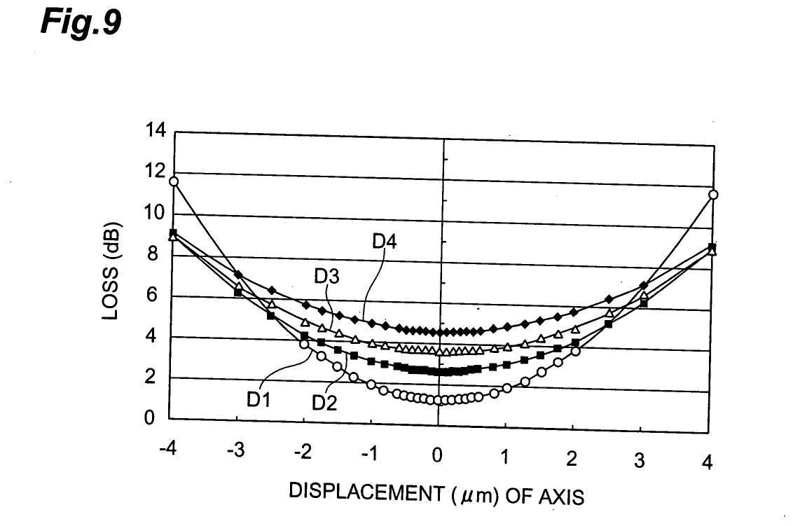

FIG. 9 is a graph showing the coupling loss between the SOA 20ᵢ and optical waveguides 31ᵢ of the integrated optical element 1A according to the first embodiment shown in FIG. 1. In this graph, the horizontal axis represents the displacement of axis (μm) of the optical axes of the SOA 20ᵢ and the optical waveguides 31ᵢ. Further, the vertical axis represents the coupling loss (dB) between the SOA 20ᵢ and the optical waveguides 31ᵢ.

Further, the distance between the downstream side end face of the SOA 20ᵢ and the upstream side end face of the optical waveguides 31ᵢ is 20 μm. Further, for the SOA 20ᵢ, an SOA with an SSC structure of which the FFP is 12° is assumed.

In addition, graphs D1 to D4 in FIG. 9 show characteristics of the coupling between the SOA 20ᵢ and the optical waveguides 31ᵢ when the relative refractive index difference Δn between the cores 36 and the cladding 37 is changed, in a condition where the core size of the optical waveguides 31ᵢ that are coupled to the SOA 20ᵢ is fixed at 4.5 μm×4.5 μm.

More specifically, graph D1 shows the characteristics when the difference Δn of the optical waveguides 31ᵢ is 1.50% and the MFD is 5.6 μm. Further, graph D2 shows the characteristics when Δn is 0.75% and the MFD is 8 μm. Graph D3 shows the characteristics when Δn is 0.65% and the MFD is 9 μm. Graph D4 shows the characteristics when Δn is 0.45% and the MFD is 10 μm. Further, the MFD of the SOA 20ᵢ is 4.8 μm for any of the graphs D1 to D4.

As can be seen from these graphs D1 to D4, when the displacement of axis of the optical axes of the SOA 20ᵢ and the optical waveguides 31ᵢ is in the range ±2 μm or less, the coupling loss is kept small when the relative refractive index difference Δn of the optical waveguides 31ᵢ is large and the MFD is small. Therefore, in the case of the integrated optical element 1A that comprises the above-described structure, the relative refractive index difference Δn between the cores 36 and cladding 37 of the optical waveguides 31ᵢ of the optical circuit element 30 is preferably set at 1.0% or more.

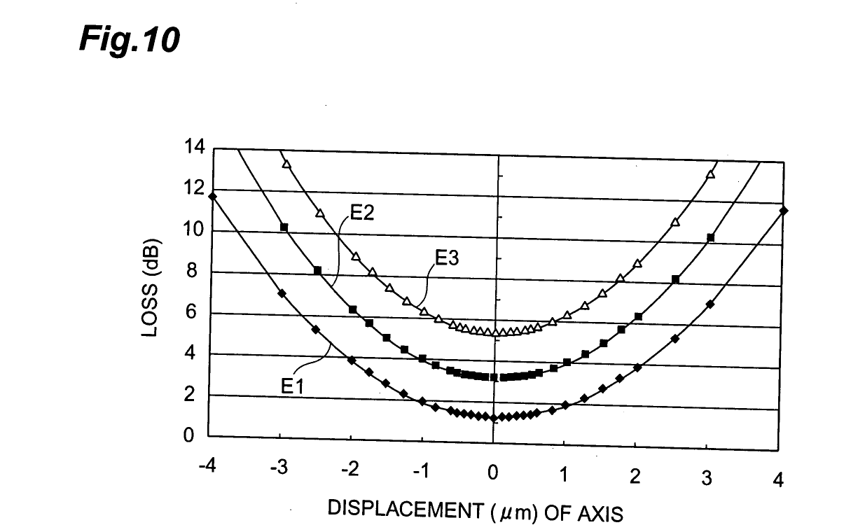

FIG. 10 is a graph showing coupling loss between the SOA 20ᵢ and the optical waveguides 31ᵢ of the integrated optical element 1A according to the first embodiment shown in FIG. 1. In this graph, the horizontal axis represents the displacement of axis (um) of the optical axes of the SOA 20ᵢ and the optical waveguides 31ᵢ, and the vertical axis represents the coupling loss (dB) between the SOA 20ᵢ and the optical waveguides 31ᵢ.

Here, the distance between the downstream side end face of the SOA 20ᵢ and the upstream side end face of the optical waveguides 31ᵢ is 20 μm. Further, for the optical waveguides 31ᵢ, an optical waveguide for which the relative refractive index difference Δn between the cores 36 and the cladding 37 is 1.5% and the MFD is 5.6 μm is assumed.

Further, graphs E1 to E3 show the coupling characteristics when the FFP of the SOA 20ᵢ with an SSC structure is changed.

In particular, graph E1 shows the characteristics when the FFP of the SOA 20ᵢ is 12°. Further, graph E2 shows the characteristics when the FFP of the SOA 20ᵢ is 16°. Graph E3 shows the characteristics when the FFP of the SOA 20ᵢ is 20°.

As shown in these graphs E1 to E3, the coupling loss is kept small when the FFP of the SOA 20ᵢ with the SSC structure is small. Therefore, in the case of the integrated optical element 1A that has the above-described structure, the FFP with this SSC structure is preferably set at 15° or less.

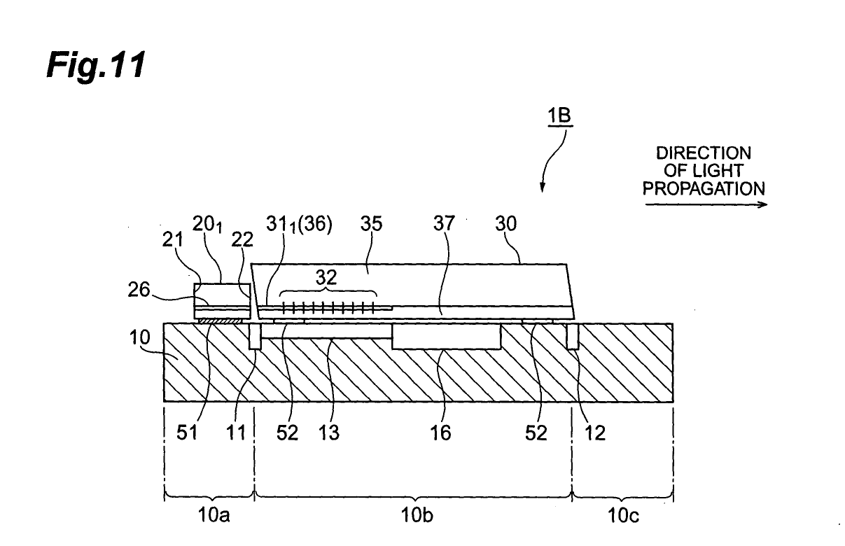

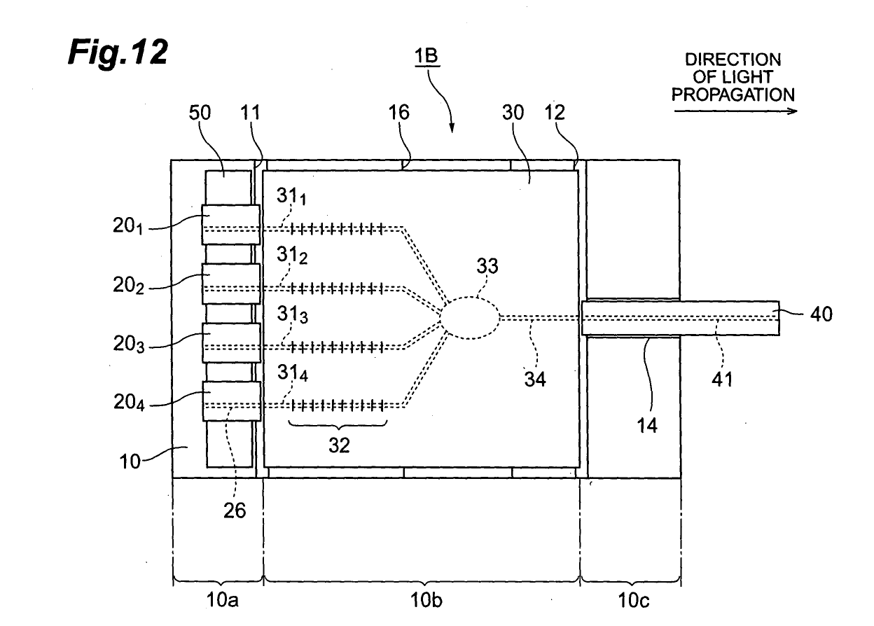

FIG. 11 shows the cross-sectional structure of the second embodiment of the integrated optical element according to the present invention. Further, FIG. 12 is a top view showing the parallel structure of the integrated optical element according to the second embodiment shown in FIG. 11. FIG. 11 shows a cross-section that contains the optical axes of the SOA 20₁ and optical waveguide 31₁ that is parallel to the direction of light propagation of the integrated optical element.

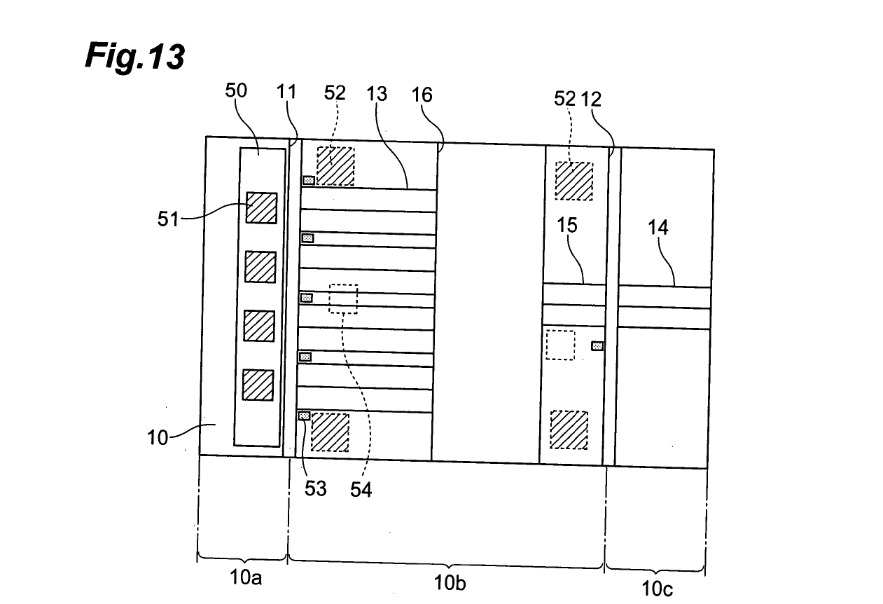

In addition, FIG. 13 is a top view showing a planar structure of a silicon bench of the integrated optical element shown in FIGS. 11 and 12. The constituent elements of the integrated optical element mounted on the silicon bench are excluded from FIG. 13.

An integrated optical element 1B according to the second embodiment comprises the silicon bench 10, the SOA 20, the optical circuit element 30, and the optical fiber 40.

The first mount surface 10a for mounting the SOA 20, the second mount surface 10b for mounting the optical circuit element 30, and the third mount surface 10c for mounting the optical fiber 40 are provided on the element mount surface of the silicon bench 10, moving in a direction from the upstream side to the downstream side in the direction of light propagation. An insulation film is also formed on the element mount surface of the silicon bench 10.

The integrated optical element 1B shown in FIGS. 11 and 12 is provided with four of the SOA 20, namely SOA 20₁ to 20₄. Each of these SOA 20ᵢ (i=1 to 4) is constituted such that the upstream side end face 21 thereof is HR coated, and the downstream side end face 22 thereof is AR coated. As a result, the SOA 20ᵢ function as optical amplifiers.

These SOA 20₁ to 20₄ are mounted (see FIG. 13) in a parallel arrangement on the first mount surface 10a of the silicon bench 10 via bonding pads 51. Further, as shown in FIG. 11, the SOA 20ᵢ are mounted in a flip chip state such that the light emission layer 26 of the SOA 20ᵢ is located next to the first mount surface 10a. Further, alignment marks formed from an electrode material are formed on the stacked film face of the SOA 20ᵢ. An electrode 50 is provided on the first mount surface 10a of the silicon bench 10 whereon the SOA 20₁ to 20₄ are mounted.

The optical circuit element 30 comprises a silica-based substrate 35; an optical waveguide layer formed by a predetermined waveguide pattern on the stacked film face of the silica-based substrate 35; and over-cladding 37 that is formed so as to cover the silica-based substrate 35 and optical waveguide layer.

In this second embodiment, the optical waveguide layer on the silica-based substrate 35 in the upstream side part of the optical circuit in the optical circuit element 30 is formed by a waveguide pattern that comprises four cores 36 in a mutually parallel arrangement, the direction of light propagation being the longitudinal direction. Accordingly, upstream side part of the optical circuit element 30 comprises four optical waveguides 31₁ to 31₄. Further, each of these optical waveguides 31ᵢ (i=1 to 4) is constituted such that the optical axis thereof is provided in a position matching the optical axis of the corresponding SOA 20ᵢ, such that the light from the SOA 20ᵢ propagates through the optical waveguides 31ᵢ.

Furthermore, optically induced Bragg gratings 32 having a predetermined reflection peak wavelength are formed in the optical waveguides 31₁ to 31₄. Further, an external resonator-type light source for generating light of a predetermined wavelength is constituted by the SOA 20ᵢ for amplifying light, and the gratings 32 provided in the associated optical waveguides 31ᵢ. In addition, the gratings 32 provided in the optical waveguides 31₁ to 31₄ have mutually different reflection peak wavelengths. As a result, the integrated optical element 1B of the second embodiment is a four-channel light source that is constituted by four external resonator-type light sources having different oscillation wavelengths.

Meanwhile, the optical waveguide layer on the silica-based substrate 35 in the downstream side part of the optical circuit in the optical circuit element 30 is formed by a waveguide pattern that comprises an optical multiplexer 33, and an output optical waveguide 34. The optical waveguides 31₁ to 31₄ on the upstream side are each connected to the optical multiplexer 33. The optical multiplexer 33 multiplexes the four channels that are input via the optical waveguides 31₁ to 31₄ and outputs the multiplexed channels to the optical waveguide 34.

Further, an AWG (Arrayed Waveguide Grating), an MZI (Mach-Zehnder Interferometer) or an MMI (Multimode Interference) coupler and so forth, for example, can be applied as the optical multiplexer 33 shown in FIG. 12.

The optical circuit element 30, which comprises the optical waveguides 31₁ to 31₄, optical multiplexer 33, and optical waveguide 34, is mounted on the second mount surface 10b of the silicon bench 10 via the bonding pads 52 (See FIG. 13). Also, as shown in FIG. 11, the optical circuit element 30 is mounted in a flip chip state such that the optical waveguide layer comprising the cores 36 is located next to the second mount surface 10b.

As shown in FIG. 13, four V grooves 13 that follow the optical waveguides 31₁ to 31₄ are formed in the second mount surface 10b of the silicon bench 10, and a V groove 15 is formed so as to follow the output optical waveguide 34. In addition, a dicing groove 16 is provided in the second mount surface 10b, in the area including the part facing the optical multiplexer 33. The dicing groove 11 is provided in the silicon bench 10, between the first mount surface 10a for mounting the SOA 20, to 204, and the second mount surface 10b for mounting the optical circuit element 30.

In the second embodiment, one optical fiber 40 is provided. This optical fiber 40 is constituted such that the optical axis of the core 41 is provided in a position matching the optical axis of the associated optical waveguide 34, such that light from the optical waveguide 34 is input to the optical fiber 40.

The optical fiber 40 is mounted on the third mount surface 10c of the silicon bench 10.

As shown in FIG. 13, the V groove 14 is formed in the third mount surface 10c of the silicon bench 10. The optical fiber 40 is aligned by the associated V groove 14. In addition, a the dicing groove 12 is provided in the silicon bench 10, between the second mount surface 10b for mounting the optical circuit element 30 and the third mount surface 10c for mounting the optical fiber 40.

As indicated by the solid lines in FIG. 13, the bonding pads 51 for mounting the SOA 20, to 204 on the silicon bench 10 are provided on the first mount surface 10a next to the silicon bench 10. Further, the bonding pads 52, which serve to mount the optical circuit element 30 comprising the optical waveguides 31, to 314, optical multiplexer 33, and optical waveguide 34 on the silicon bench 10, are provided, via a metal layer, on the surface of the cladding 37 next to the optical circuit element 30 which faces the second mount surface 10b of the silicon bench 10, as indicated by the broken lines in FIG. 13.

The alignment marks 53, which are recognized by a die bonder when the SOA 20₁ to 20₄ and optical circuit element 30 are mounted on the element mount surface, are formed on the second mount surface 10b of the silicon bench 10. Likewise, alignment marks 54 are formed on the surface of the cladding 37 of the optical circuit element 30.

Next, the effects of the integrated optical element according to the second embodiment will be described.

Two types of optical devices, namely the SOA 20₁ to 20₄ and the optical circuit element 30, are used separately in the fabrication of the integrated optical element 1B according to the second embodiment shown in FIGS. 11 to 13. Further, the integrated optical element 1B is obtained by mounting the SOA 20₁ to 20₄ and the optical circuit element 30 on predetermined surfaces of the silicon bench 10 that are provided separately from the substrate 35 for the optical circuit element 30. As a result, the integrated optical element 1B, in which optical waveguides 31₁ to 31₄ having favorable characteristics such as polarization dependence are integrated with the SOA 20₁ to 20₄, is obtained. In addition, because optical devices of two types are fabricated separately, the fabrication yield of the integrated optical element 1B increases rapidly.

Furthermore, for the constitution of the optical circuit element 30, in addition to the constitution of the integrated optical element 1A according to the first embodiment shown in FIG. 1, it is possible to employ an optical circuit element in which an optical waveguide is formed by an optical circuit pattern that comprises the optical multiplexer 33 as per the second embodiment. In this constitution, outputs can be made from a single optical fiber 40 by multiplexing the four channels generated.

Next, a description will be provided for a light source module in which an integrated optical element with the above-described structure (the integrated optical element according to the present invention) is applied.

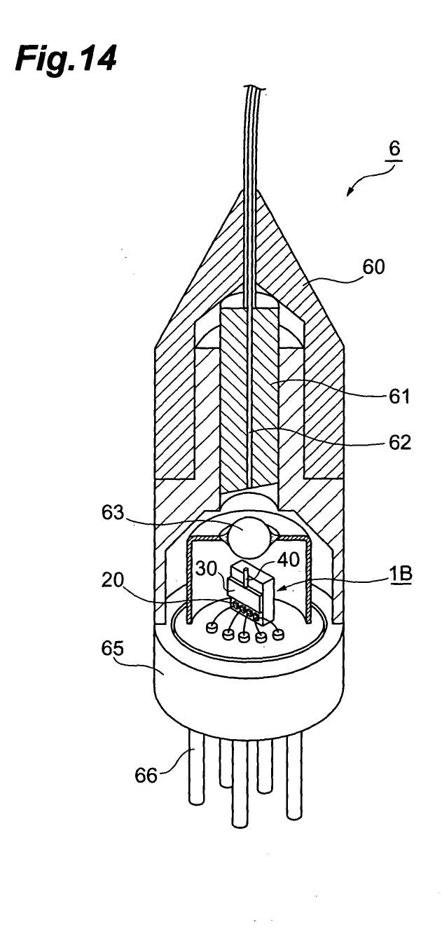

FIG. 14 is a partially exploded cross-section showing the constitution of the first embodiment of the light source module according to the present invention. The light source module 6 according to the first embodiment is an optical module in which the integrated optical element 1B shown in FIG. 11 that constitutes a four-channel light source is installed in a substantially cylindrical housing 60. In the integrated optical element 1B, the light of four channels that is generated by the SOA 20₁ to 20₄ and the optical waveguides 31₁ to 31₄ is multiplexed by the optical multiplexer 33, and then output via the optical fiber 40.

A ferrule 61, a lens 63, and the integrated optical element 1B are installed so as to achieve a match between the optical axes thereof, in the housing 60 of the light source module 6. The integrated optical element 1B is installed on the base 65 of the housing 60 such that the SOA 20₁ to 20₄ are located next to the base 65 and the optical fiber 40 is located next to the lens 63. In addition, pins 66 for supplying the required electrical signals and so forth to the elements of the integrated optical element 1B are provided in the base 65.

In the above constitution, light that is output by the integrated optical element 1B is input to an optical fiber 62 that passes through the ferrule 61, via a condenser lens 63, and is output to the outside via this optical fiber 62.

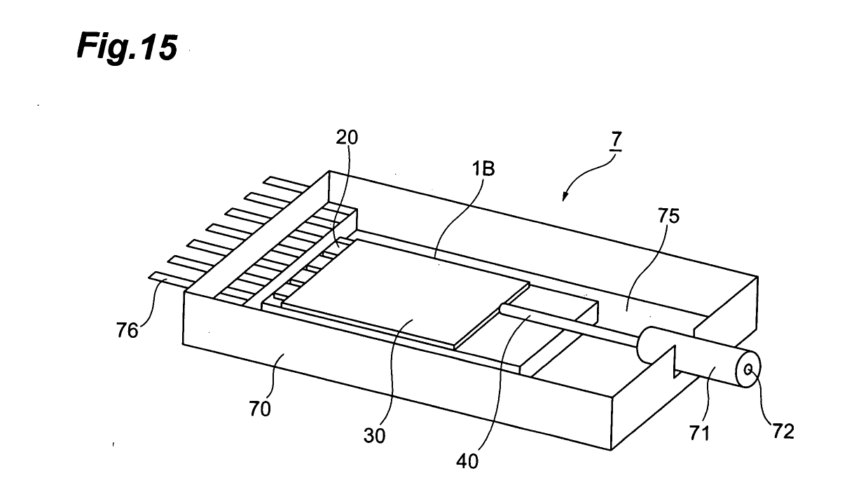

FIG. 15 is a perspective view showing the constitution of the second embodiment of the light source module according to the present invention. A light source module 7 according to the second embodiment is an optical module in which the integrated optical element 1B shown in FIG. 11 that constitutes a four channel light source is installed in a substantially square-shaped package 70.

A ferrule 71 and the integrated optical element 1B are installed so as to achieve a match between the optical axes thereof, in the package 70 of the light source module 7. The integrated optical element 1B is installed such that the SOA 20, to 204 are located on the opposite side from the ferrule 71 and the optical fiber 40 is located next to the ferrule 71, on the bottom 75 of the package 70. Further, the optical fiber 40 is connected to an optical fiber 72 that passes through the ferrule 71. Pins 76 for supplying the required electrical signals and so forth to the elements of the integrated optical element 1B are provided in a surface next to the SOA 20, to 204 of the package 70.

In the above constitution, the light output from the integrated optical element 1B is input via the optical fiber 40 to the optical fiber 72 that passes through the ferrule 71 and then output to the outside via the optical fiber 72.

As in the case of the light source modules 6 and 7 of FIGS. 14 and 15, an optical transmission light source module whose light source is an integrated optical element having favorable characteristics such as polarization dependence is obtained by using the integrated optical element of the above-described constitution to output light from the light source constituted by the optical semiconductor element and the optical circuit element that are mounted on the silicon bench. Further, in the case of this light source module, the integrated optical element 1A shown in FIG. 1 may be applied.

The integrated optical element, fabrication method for this integrated optical element, and light source module according to the present invention are not limited to or by the above embodiments, a variety of modifications being possible. For example, in the case of the integrated optical elements 1A and 1B shown in FIGS. 1 and 11, the semiconductor optical amplifiers 20₁ to 20₄ are used as optical semiconductor elements, and the gratings 32 are formed in the optical waveguides 31₁ to 31₄, whereby an external resonator-type light source is formed. Accordingly, the constitution may be one in which a semiconductor laser element is used as the optical semiconductor element and gratings are not formed in the optical waveguides.

Moreover, although both the integrated optical elements 1A and 1B are constituted as a four channel light source, generally, the integrated optical elements 1A and 1B can be a light source with one or more channel (s) constituted by one or more optical semiconductor element(s) and optical waveguide(s). With regard to the mounting of the elements on the silicon bench, a mounting method other than the flip chip mounting method is acceptable depending on the alignment accuracy and so forth required.

According to the invention described hereinabove, optical semiconductor elements for outputting light of a predetermined wavelength, and an optical circuit element in which optical waveguides that propagate the light from the optical semiconductor elements are formed on a substrate, are mounted on a separately prepared silicon bench via a bonding material. For this reason, substrates of suitable materials can be used as the substrate whereon the optical semiconductor elements are mounted and the substrate for the optical circuit element on which the optical waveguides are formed.

Therefore, an integrated optical element, in which an optical waveguide having favorable characteristics such as polarization dependence is integrated with an optical semiconductor element, and a fabrication method for the integrated optical element, are obtained. Furthermore, because optical devices of two types are fabricated separately, the fabrication yield of the integrated optical element can be improved.

Moreover, in the case of the light source module that comprises the above-described integrated optical element and that outputs light from the light source constituted by the optical semiconductor element and the optical circuit element, an optical transmission light source module whose light source is an integrated optical element having favorable characteristics such as polarization dependence is obtained.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An integrated optical element, comprising:
an optical semiconductor element including a light emission layer and outputting light of a predetermined wavelength;
an optical circuit element including a substrate, an optical waveguide in which the light from said optical semiconductor element propagates and which is provided on said substrate, and a grating formed in said optical waveguide and constituting an external resonator together with said optical semiconductor element;
a silicon bench having an element mount surface on which said optical semiconductor element and said optical circuit element are mounted; and
a bonding material for fixing said optical circuit element in a predetermined position on the element mount surface of said silicon bench, while being apart from said silicon bench at a predetermined distance.

2. An integrated optical element according to claim 1, wherein a placement position of the light emission layer, in a cross-section of said optical semiconductor element that is orthogonal to the light emission layer, is shifted further toward an outer periphery side of the cross-section than a center of the cross-section, and said optical semiconductor element is placed on the element mount surface of said silicon bench such that a distance between the light emission layer and said silicon bench is minimized; and,
wherein a placement position of said optical waveguide, in a cross-section of said optical circuit element that is orthogonal to said optical waveguide, is shifted further toward an outer periphery side of the cross-section than a center of the cross-section, and said optical circuit element is placed on the element mount surface of said silicon bench such that a distance between said optical waveguide and said silicon bench is minimized.

3. An integrated optical element according to claim 1, wherein said optical semiconductor element includes a semiconductor optical amplifier whose end face facing said optical waveguide in said optical circuit element is Anti-Reflection coated.

4. An integrated optical element according to claim 1, wherein an interval between an end face of said optical semiconductor element facing said optical waveguide and said optical waveguide in said optical circuit element is filled with resin.

5. An integrated optical element according to claim 4, wherein the resin has a refractive index of 1.300 or more but 1.444 or less.

6. An integrated optical semiconductor element according to claim 1, wherein an end face of said optical circuit element which faces the optical semiconductor element is inclined at an angle of 3° or more but 8° or less with respect to a surface that is orthogonal to an optical axis of the light from said optical semiconductor element.

7. An integrated optical semiconductor element according to claim 1, wherein said substrate in said optical circuit element includes a silica-based substrate.

8. An integrated optical element according to claim 1, wherein an optical semiconductor element has a spot-size conversion structure whose FFP is 15° or less; and
a relative refractive index difference between a core and a cladding of said optical waveguide in said optical circuit element is 1.0% or more.

9. A method for fabricating an optical semiconductor element according to claim 1, comprising the steps of:
preparing an optical semiconductor element including a light emission layer and outputting light of a predetermined wavelength;
preparing an optical circuit element including a substrate, an optical waveguide in which the light from said optical semiconductor element propagates and which is provided on said substrate, and a grating formed in said optical waveguide and constituting an external resonator together with said optical semiconductor element;
preparing a silicon bench;
fixing said optical semiconductor element in a first region on an element mount surface of said silicon bench via a first bonding material; and
fixing said optical circuit element in a second region on the element mount surface of said silicon bench via a second bonding material, the second region differing from the first region.

10. A method according to claim 9, wherein a placement position of the light emission layer, in a cross-section of said optical semiconductor element that is orthogonal to the light emission layer, is shifted further toward an outer periphery side of the cross-section than a center of the cross-section, and said optical semiconductor element is placed on the element mount surface of said silicon bench such that a distance between the light emission layer and said silicon bench is minimized, and
wherein a placement position of said optical waveguide, in a cross-section of said optical circuit element that is orthogonal to said optical waveguide, is shifted further toward an outer periphery side of the cross-section than a center of the cross-section, and said optical circuit element is placed on the element mount surface of said silicon bench such that a distance between said optical waveguide and said silicon bench is minimized.

11. A method according to claim 9, wherein glass layers for a core and a cladding constituting said optical waveguide in said optical circuit element are formed by CVD.

12. A method according to claim 9, wherein, on the element mount surface of the silicon bench by means of a KOH etching process, a V groove for mounting an optical fiber to which the light from said optical waveguide in said optical circuit element is input, and an alignment mark for recognition by a die bonder when said optical semiconductor element and said optical circuit element are mounted, are formed batchwise.

13. A method according to claim 9, wherein said optical circuit element is mounted on the element mount surface after said optical semiconductor element has been mounted on the element mount surface of said silicon bench.

14. A light source module, including an integrated optical element according to claim 1.

15. An integrated optical element, comprising:
N (integer of 2 or more) optical semiconductor elements each including a light emission layer;
an optical circuit element including a substrate, N optical waveguides each corresponding to the associated one of said N optical semiconductor elements and provided on said substrate, and N gratings each formed in the associated one of said N optical waveguides and having a reflection peak wavelength different from each other;
a silicon bench having an element mount surface on which said N optical semiconductor elements and said optical circuit element are mounted; and
a bonding material provided between each of said N optical semiconductor elements and said silicon bench, and fixing said optical semiconductor elements in predetermined positions on the element mount surface of said silicon bench.

16. An integrated optical element according to claim 15, wherein said optical circuit element further includes an optical multiplexer for multiplexing the light propagating through said N optical waveguides.

17. An integrated optical element according to claim 15, wherein a placement position of the light emission layer, in a cross-section of each of said N optical semiconductor elements that is orthogonal to the light emission layer, is shifted further toward an outer periphery side of the cross-section than a center of the cross-section, and said N optical semiconductor elements are each placed on the element mount surface of said silicon bench such that a distance between the light emission layer and said silicon bench is minimized, and
wherein a placement position of each of said N optical waveguides, in a cross-section of said optical circuit element that is orthogonal to said N optical waveguides, is shifted further toward an outer periphery side of the cross-section than a center of the cross-section, and said optical circuit element is placed on the element mount surface of said silicon bench such that a distance between said N optical waveguides and said silicon bench is minimized.

18. An integrated optical element according to claim 15, wherein each of said N optical semiconductor elements includes a semiconductor optical amplifier whose end face facing the associated one of said N optical waveguides in said optical circuit element is Anti-Reflection coated.

19. An integrated optical element according to claim 15, wherein an interval between respective end faces of said N semiconductor optical amplifiers facing said N optical waveguides and said N optical waveguides in said optical circuit element is filled with resin.

20. An integrated optical element according to claim 19, wherein the resin has a refractive index of 1.300 or more but 1.444 or less.

21. An integrated optical semiconductor element according to claim 15, wherein respective end faces of said optical circuit element facing said N optical semiconductor elements is inclined at an angle of 3° or more but 8° or less with respect to a surface that is orthogonal to an optical axis of the light from said N optical semiconductor elements.

22. An integrated optical semiconductor element according to claim 15, wherein said substrate in said optical circuit element include a silica-based substrate.

23. An integrated optical element according to claim 15, wherein each of said N semiconductor optical amplifiers has a spot-size conversion structure whose FFP is 15° or less, and
wherein a relative refractive index core and a cladding of each of said N optical waveguides in said optical circuit element is 1.0% or more.

24. A method for fabricating an optical semiconductor element according to claim 15, comprising the steps of:
preparing N (integer of 2 or more) optical semiconductor elements each including a light emission layer and outputting light of mutually different wavelengths;
preparing an optical circuit element including a substrate, N optical waveguides each corresponding to the associated one of said N optical semiconductor elements and provided on said substrate, and N gratings each formed in the associated one of said N optical waveguides and having a reflection peak wavelength different from each other;
preparing a silicon bench;
fixing each of said N optical semiconductor elements in first regions on the element mount surface of said silicon bench via a first bonding material; and
fixing said optical circuit element in a second region on the element mount surface of said silicon bench via a second bonding material, the second region differing from the first regions.

25. A method according to claim 24, wherein a placement position of the light emission layer, in a cross-section of each of said N optical semiconductor elements that is orthogonal to the light emission layer, is shifted further toward an outer periphery side of the cross-section than a center of the cross-section, and said N optical semiconductor elements are each placed on the element mount surface of said silicon bench such that a distance between the light emission layer and said silicon bench is minimized, and
wherein a placement position of each of said N optical waveguides, in a cross-section of said optical circuit element that is orthogonal to said N optical waveguides, is shifted further toward an outer periphery side of the cross-section than a center of the cross-section, and said optical circuit element is placed on the element mount surface of said silicon bench such that a distance between said N optical waveguides and said silicon bench is minimized.

26. A method according to claim 24, wherein glass layers for a core and a cladding constituting each of said N optical waveguides in said optical circuit element are formed by CVD.

27. A method according to claim 24, wherein, on the element mount surface of the silicon bench by means of a KOH etching process, V grooves each for mounting optical fibers to which the light from said N optical waveguides in said optical circuit element is input, and alignment marks each for recognition by a die bonder when said N optical semiconductor elements and said optical circuit element are mounted, are formed batchwise.

28. A method according to claim 24, wherein said optical circuit element is mounted on the element mount surface after said N optical semiconductor elements have been mounted on the element mount surface of said silicon bench.

29. A light source module, including an integrated optical element according to claim 15.
